(19) United States
(12) Patent Application Publication
(10) Pub. No.: US 2016/0318345 A1
(43) Pub. Date: Nov. 3, 2016

(54) Crown Reinforcement of a Tire for a Heavy Civil Engineering Vehicle

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventor: Olivier SEJALON, Clermont-Ferrand Cedex 9 (FR)

(21) Appl. No.: 15/104,877

(22) PCT Filed: Dec. 17, 2014
(86) PCT No.: PCT/EP2014/078157

§ 371 Date: Jun. 15, 2016

(30) Foreign Application Priority Data
Dec. 18, 2013 (FR) 1362848

(51) Int. Cl. B60C 9/28; B60C 9/20

(52) U.S. Cl. CPC B60C 9/28; B60C 9/2006; B60C 2009/2016; B60C 2009/2019; B60C 2200/065; B60C 2009/2041

(57) ABSTRACT

Tire (1) crown reinforcement (3) comprises: protective reinforcement (5) comprising layer (51, 52) comprising reinforcers forming, with the circumferential direction, an angle at least equal to 10°; working reinforcement (6) comprising two layers (61, 62) respectively having axial width (L₆₁, L₆₂) and comprising reinforcers, crossed from one working layer to the next and forming, with the circumferential direction, an angle at most equal to 60°; and additional reinforcement (7), centred axially on an equatorial plane of the tire, comprising layer (71, 72) having axial width (L₇₁, L₇₂) at most equal to 0.9 times the shortest of the axial widths (L₆₁, L₆₂) and comprising reinforcers forming, with the circumferential direction, an angle at most equal to 25°. Additional layer (71, 72) comprises axial discontinuity (81, 82), centred axially on the equatorial plane of the tire, and its width (D₁, D₂) is at least equal to 0.1 times axial width (L₇₁, L₇₂).

The present invention relates to a radial tire intended to be fitted to a heavy vehicle of civil engineering type and, more particularly, to the crown of such a tire.

Although not restricted to this type of application, the invention is described with reference to a large-sized radial tire intended to be mounted on a dumper, which is a vehicle that transports materials extracted from quarries or open cast mines. Typically, a radial tire for a heavy vehicle of civil engineering type, within the meaning of the European Tire and Rim Technical Organisation or ETRTO standard, is intended to be mounted on an at least 25-inch rim.

A tire comprises two beads which provide the mechanical connection between the tire and the rim on which it is mounted, the beads being joined respectively via two sidewalls to a tread which is intended to come into contact with the ground via a tread surface.

Because a tire has a geometry of revolution with respect to an axis of rotation, the geometry of the tire is generally described in a meridian plane containing the axis of rotation of the tire. For a given meridian plane, the radial, axial and circumferential directions respectively denote the directions perpendicular to the axis of rotation of the tire, parallel to the axis of rotation of the tire and perpendicular to the meridian plane.

In what follows, the expressions “radially on the inside or, respectively, radially on the outside” mean “closer to, or, respectively, further away from, the axis of rotation of the tire”. “Axially on the inside or, respectively, axially on the outside” mean “closer to, or, respectively, further away from, the equatorial plane of the tire”, the equatorial plane of the tire being the plane passing through the middle of the tread surface of the tire and perpendicular to the axis of rotation of the tire.

A radial tire comprises a reinforcing structure, made up of a crown reinforcement, radially on the inside of the tread, and of a carcass reinforcement, radially on the inside of the crown reinforcement.

The carcass reinforcement of a radial tire for a heavy vehicle of civil engineering type usually comprises at least one carcass layer made up of reinforcers, generally metal, coated with a polymeric material of elastomer type referred to as a skim compound. A carcass layer comprises a main part, connecting the two beads together and turned up, generally, within each bead, from the inside towards the outside of the tire, around a circumferential reinforcing element, usually metal, referred to as a bead wire, to form a turn up. The metal reinforcers of a carcass layer are substantially parallel to one another and form, with the circumferential direction, an angle of between 85° and 95°.

The crown reinforcement of a radial tire for a heavy vehicle of civil engineering type comprises a superposition of crown layers which are arranged circumferentially, radially on the outside of the carcass reinforcement. Each crown layer is made up of reinforcers, generally metal, parallel to one another and coated with a polymeric material of elastomer type or skim compound.

Among the crown layers a distinction is usually made between the protective layers, which make up the protective reinforcement and are radially outermost, and the working layers, which make up the working reinforcement and are comprised radially between the protective reinforcement and the carcass reinforcement.

The protective reinforcement, made up of at least one protective layer, essentially protects the working layers from mechanical or physico-chemical attack likely to spread through the tread radially towards the inside of the tire.

The protective reinforcement often comprises two, radially superposed, protective layers, formed of elastic metal reinforcers, parallel to one another within each layer and crossed from one layer to the next, thereby forming, with the circumferential direction, angles at least equal to 10° and at most equal to 35° and, for preference, at least equal to 15° and at most equal to 30°.

The working reinforcement, made up of at least two working layers, has the function of belting the tire and of providing the tire with rigidity and road holding. It absorbs both the mechanical stresses of inflation, which are generated by the tire inflation pressure and transmitted via the carcass reinforcement, and the mechanical stresses of running, which are generated by the running of the tire over the ground and are transmitted by the tread. It also needs to resist oxidation, shocks and perforation, by virtue of its own intrinsic design and that of the protective reinforcement.

The working reinforcement usually comprises two, radially superposed, working layers formed of inelastic metal reinforcers parallel to one another within each layer and crossed from one layer to the next, thereby forming, with the circumferential direction, angles at most equal to 60° and preferably at least equal to 15° and at most equal to 45°.

A metal reinforcer is mechanically characterized by a curve representing the tensile force (in N) applied to the metal reinforcer as a function of the relative elongation (in %) of the metal reinforcer and referred to as the force-elongation curve. Mechanical tensile characteristics of the metal reinforcer, such as the structural elongation A_{S} (in %), the total elongation at break Aₜ (in %), the force at break Fₘ (maximum load in N) and the breaking strength Rₘ (in MPa) are deduced from this force-elongation curve, these characteristics being measured in accordance with standard ISO 6892, 1984.

The total elongation at break Aₜ of the metal reinforcer is, by definition, the sum of its structural, elastic and plastic elongations (Aₜ=Aₛ+Aₑ+Aₚ). The structural elongation A_{S} is the result of the relative positioning of the metal wires that make up the metal reinforcer under light tensile loading. The elastic elongation Aₑ is the result of the very elasticity of the metal of the metal wires that make up the metal reinforcer, considered individually (Hooke's law). The plastic elongation Aₚ results from the plasticity (irreversible deformation beyond the elastic limit) of the metal of these metal wires considered individually. These various elongations and their respective significances, which are well known to those skilled in the art, are described, for example, in documents U.S. Pat. No. 5,843,583, WO 2005/014925 and WO 2007/090603.

At any point on the force-elongation curve there is also defined an extension modulus (in GPa) which represents the gradient of the straight line tangential to the force-elongation curve at that point. In particular, the extension modulus of the elastic linear part of the force-elongation curve is referred to as the extension elastic modulus or Young's modulus.

Among metal reinforcers, a distinction is usually made between elastic metal reinforcers, such as those used in the protective layers, and inelastic metal reinforcers, such as those used in the working layers.

An elastic metal reinforcer is characterized by a structural elongation Aₛ at least equal to 1% and a total elongation at break Aₜ at least equal to 4%. Furthermore, an elastic metal reinforcer has an extension elastic modulus at most equal to 150 GPa, and usually comprised between 40 GPa and 150 GPa.

An inelastic metal reinforcer is characterized by a relative elongation, under a tensile force equal to 10% of the force at break Fₘ, at most equal to 0.2%. Moreover, an inelastic metal reinforcer has an extension elastic modulus usually comprised between 150 GPa and 200 GPa.

In order to reduce the mechanical stresses of inflation transmitted to the working reinforcement, it is known practice, from documents FR 2 419 181 and FR 2 419 182 to arrange radially between the working reinforcement and the carcass reinforcement an additional reinforcement, referred to as limiting block, the purpose of which is to at least partially absorb the mechanical stresses of inflation.

Document FR 2 419 181 describes and claims a crown reinforcement comprising a working reinforcement, made up of at least two working layers the metal reinforcers of which form, with the circumferential direction, angles which are opposite from one layer to the other and at least equal to 30°, and an additional reinforcement or limiting block, comprising at least two additional layers the metal reinforcers of which have only very low extensibility, which means to say are inelastic, and form, with the circumferential direction, angles which are opposite from one layer to the other and at most equal to one quarter of the smallest angle of the working layers. This limiting block is centred on the equatorial plane and has a width at most equal to the width of crown reinforcement over which the crown reinforcement and the carcass reinforcement are parallel to one another.

Document FR 2 419 182 describes and claims a crown reinforcement comprising a working reinforcement, made up of at least two working layers the metal reinforcers of which form, with the circumferential direction, angles which are opposite from one layer to the other and at least equal to 30°, and an additional reinforcement or limiting block, comprising at least two additional layers the metal reinforcers of which have only very low extensibility, which means to say are inelastic, and form, with the circumferential direction, angles which are the opposite from one layer to the other and at most equal to one half of the smallest angle of the working layers and, preferably, comprised between 5° and 10°. This limiting block is centred on the equatorial plane and has a width at most equal to the width of crown reinforcement over which the crown reinforcement and the carcass reinforcement are parallel to one another.

However, an additional reinforcement, made up of two layers the metal reinforcers of which are inelastic and form, with the circumferential direction, angles that are crossed from one layer to the next and preferably comprised between 5° and 10°, causes excessive stiffening of the crown reinforcement. This stiffening of the crown reinforcement leads to an increase in the sensitivity of the tire to the shocks that occur at the centre of the tread. This is because a great deal of the deformation energy generated by the shocks is then transmitted to the carcass reinforcement, the life of which is therefore reduced.

The inventors set themselves the objective of making the crown of a radial tire for a heavy vehicle of civil engineering type less sensitive to the shocks that essentially occur at the centre of the tread.

This objective was achieved, according to the invention, by a tire for heavy vehicle of civil engineering type, comprising:
a crown reinforcement radially on the inside of a tread and radially on the outside of a carcass reinforcement,
the crown reinforcement comprising, radially from the outside towards the inside, a protective reinforcement, a working reinforcement and an additional reinforcement,
the protective reinforcement comprising at least one protective layer comprising elastic metal reinforcers which form, with the circumferential direction, an angle at least equal to 10°,
the working reinforcement comprising at least two working layers respectively having an axial width and comprising inelastic metal reinforcers, crossed from one working layer to the next and which form, with the circumferential direction, an angle at most equal to 60°,
the additional reinforcement, centred axially on an equatorial plane of the tire, comprising at least one additional layer having an axial width at most equal to 0.9 times the shortest of the axial widths of the at least two working layers and comprising metal reinforcers which form, with the circumferential direction, an angle at most equal to 25°,
at least one additional layer comprising an axial discontinuity, centred axially on the equatorial plane of the tire,
the width of the axial discontinuity being at least equal to 0.1 times the axial width of the at least one additional layer.

By comparison with a crown reinforcement of a reference tire of the prior art, comprising an additional reinforcement comprising at least one additional layer without an axial discontinuity, that means to say an additional layer that is continuous, a crown reinforcement of a tire according to the invention, comprising an additional reinforcement comprising at least one additional layer with an axial discontinuity, namely an additional layer that is discontinuous or interrupted, has a reduced circumferential extension rigidity in its middle portion, centred on the equatorial plane.

The circumferential extension rigidity of the crown reinforcement means here the tensile force that has to be exerted on a unit width of the crown reinforcement in order to obtain a 1 mm elongation of the said crown reinforcement.

It is dependent in particular on the extension modulus of the metal reinforcers and on the angles formed, with the circumferential direction, by the said metal reinforcers of the various crown layers. The circumferential extension rigidity may be defined for the crown reinforcement overall or for the reinforcements that make up the crown reinforcement, such as the additional reinforcement or the working reinforcement.

When it is said that the crown reinforcement has reduced circumferential extension rigidity in its middle portion, that means that it has a circumferential extension rigidity at most equal to 0.5 times, or even at most equal to 0.3 times, the circumferential extension rigidity of the crown reinforcement of the reference tire, which is at a maximum at the equatorial plane.

Specifically, the presence of an axial discontinuity in an additional layer, centred axially on the equatorial plane of the tire, which means to say positioned in the middle part, implies that, at this axial discontinuity, the additional layer makes no contribution to the circumferential extension rigidity of the crown reinforcement, thereby reducing the said circumferential extension rigidity. As a result, a softening of the middle part of the crown reinforcement allows the crown of the tire to deform to a greater extent in this zone and therefore provides a greater ability to absorb deformation energy resulting from the shocks likely to occur at the centre of the tread of the tire.

Furthermore, the axial discontinuity leads not only to a reduction in the maximum circumferential extension rigidity of the crown reinforcement but also to a shifting of this maximum axially towards the outside of the middle part. Moreover, the distribution of the circumferential extension rigidity across the axial width of the crown reinforcement is more uniform, which implies that the impact resistance is relatively uniform across the entire width of the tread. A relatively uniform distribution of the circumferential extension rigidity of the crown reinforcement encourages more even tread wear when the tire is highly stressed in terms of driving or braking torque, as when used in mining.

In order to have sufficient effectiveness in terms of reducing the circumferential extension rigidity, the width of the axial discontinuity is, according to the invention, at least equal to 0.1 times the axial width of the at least one additional layer.

The angle formed, with the circumferential direction, by the metal reinforcers of the at least one additional layer is advantageously at least equal to 10°. This minimum angle limits the maximum circumferential extension rigidity of the crown reinforcement, reached outside of the middle part. It also contributes to making the axial ends of the working layers less sensitive to cracking, thereby improving the endurance of the crown reinforcement. Because the minimum angle is at least equal to 10°, the additional layer is therefore not circumferential, that qualification being often reserved for layers that make angles at most equal to 10°.

The axial width of the at least one additional layer is likewise advantageously at least equal to 0.4 times the shortest of the axial widths of the at least two working layers. This minimum axial width end point limits the maximum circumferential extension rigidity of the crown reinforcement achieved outside of the middle part. It also guarantees relatively uniform distribution of the circumferential extension rigidity of the crown reinforcement over a part of the crown reinforcement of significant axial width.

The width of the axial discontinuity of the at least one additional layer is again advantageously at most equal to 0.35 times the axial width of the at least one additional layer. This maximum width of the axial discontinuity guarantees significant hooping of the carcass reinforcement by the additional reinforcement. Beyond this value, the circumferential extension rigidity of the crown reinforcement becomes too low.

According to a preferred embodiment, the additional reinforcement comprises at least two additional layers. The presence of at least two additional layers allows the additional reinforcement to make a significant contribution to the circumferential extension rigidity of the crown reinforcement.

According to a first alternative form of the preferred embodiment in which the additional reinforcement comprises at least two additional layers, the radially innermost additional layer comprises an axial discontinuity.

According to a second alternative form of the preferred embodiment in which the additional reinforcement comprises at least two additional layers, the radially outermost additional layer comprises an axial discontinuity.

According to a third alternative form of the preferred embodiment in which the additional reinforcement comprises at least two additional layers, the at least two additional layers respectively comprise an axial discontinuity.

Since the additional reinforcement comprises at least two additional layers, the respective axial discontinuities of the at least two additional layers advantageously have respective widths that differ one from the other. In other words, the axial limits of the respective discontinuities of the two additional layers do not coincide, making it possible to spread the mechanical stresses in this zone.

Since the additional reinforcement comprises at least two additional layers, the respective axial widths of the at least two additional layers are also advantageously different one from the other. In other words, the axial ends of the two additional layers do not coincide, making it possible to spread the mechanical stress in this zone.

According to a first alternative form relating to the reinforcers of the additional layer, the metal reinforcers of the at least one additional layer are inelastic.

According to a second alternative form relating to the reinforcers of the additional layer, the metal reinforcers of the at least one additional layer are elastic.

The elastic metal reinforcers of each protective layer preferably form, with the circumferential direction, an angle at least equal to 15° and at most equal to 30°.

For preference, the inelastic metal reinforcers of each working layer form, with the circumferential direction, an angle at least equal to 15° and at most equal to 45°.

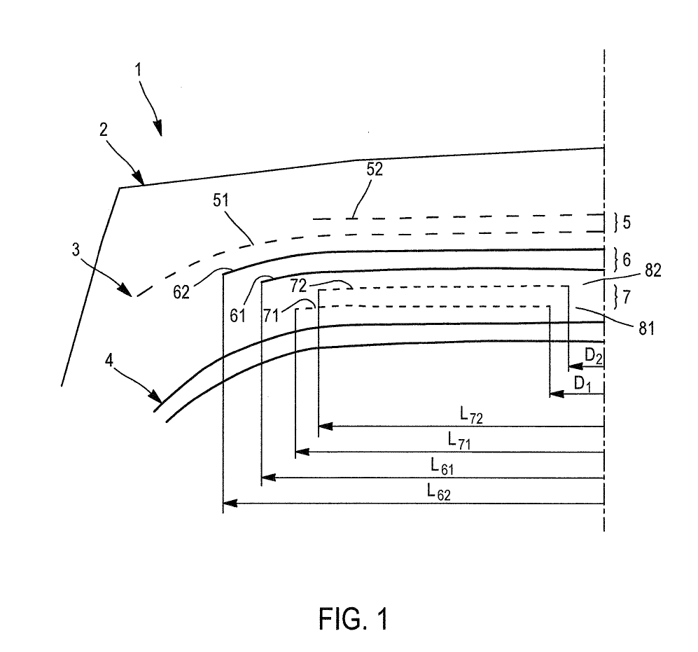

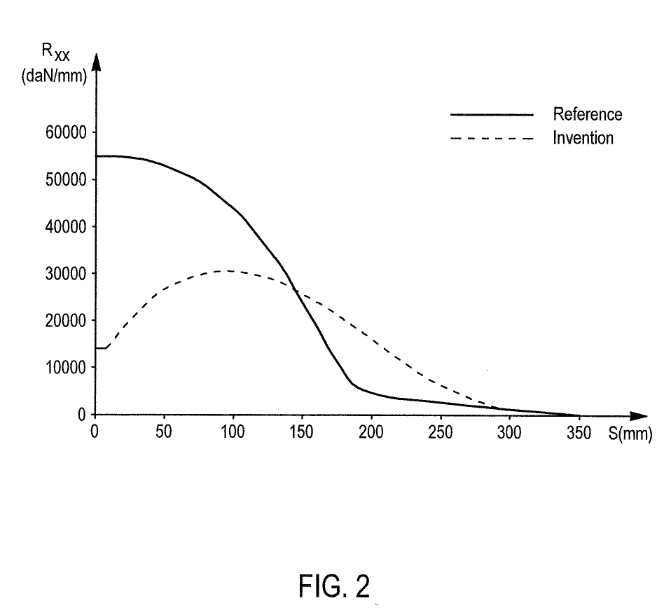

The features of the invention are illustrated by the schematic FIGS. 1 and 2 which are not drawn to scale.

FIG. 1 depicts a meridian half-section of the crown of a tire 1 for heavy vehicle of civil engineering type, comprising:
a crown reinforcement 3 radially on the inside of a tread 2 and radially on the outside of a carcass reinforcement 4,
the crown reinforcement 3 comprising, radially from the outside towards the inside, a protective reinforcement 5, a working reinforcement 6 and an additional reinforcement 7,
the protective reinforcement 5 comprising two protective layers comprising elastic metal reinforcers which form, with the circumferential direction, an angle at least equal to 10°,
the working reinforcement 6 comprising two working layers (61, 62) respectively having an axial width (L₆₁, L₆₂) and comprising inelastic metal reinforcers, crossed from one working layer to the next and which form, with the circumferential direction, an angle at most equal to 60°,
the additional reinforcement 7, centred axially on an equatorial plane of the tire, comprising two additional layers (71, 72) respectively having an axial width (L₇₁, L₇₂) at most equal to 0.9 times the shortest of the axial widths (L₆₁, L₆₂) of the at least two working layers (61, 62) and comprising metal reinforcers which form, with the circumferential direction, an angle at most equal to 25°.

For the embodiment depicted in FIG. 1, the additional layers (71, 72) have distinct axial widths (L₇₁, L₇₂) and comprise axial discontinuities (81, 82) having distinct respective widths (D₁, D₂).

FIG. 2 depicts the respective distributions of circumferential extension rigidity Rxx of the crown reinforcement for a reference tire of the prior art, in solid line, and for a tire according to the invention, in dotted line. The circumferential extension rigidity Rxx, expressed in daN/mm, is represented as a function of the curvilinear abscissa S, expressed in mm, of the middle line of the crown reinforcement comprised between the equatorial plane and an axial end of the crown reinforcement, namely over a meridian half-section of the tire. The reference tire comprises an additional reinforcement comprising two additional layers without axial discontinuity, namely two additional layers that are continuous. The tire according to the invention comprises an additional reinforcement comprising two additional layers with an axial discontinuity, namely two additional layers which are discontinuous or interrupted.

The invention was studied more particularly in the case of a tire of size 40.00R57.

In the example studied, the crown reinforcement 3 of the reference tire 1 comprises, radially from the outside inwards:
a protective reinforcement 5 comprising two protective layers (51, 52) formed of elastic metal reinforcers, crossed from one protective layer to the next and forming, with the circumferential direction, an angle equal to 24°, the radially outer protective layer 52 having an axial width equal to 315 mm and the radially inner protective layer 51 having an axial width equal to 444 mm,
a working reinforcement 6 comprising two working layers (61, 62) formed of inelastic metal reinforcers, crossed from one working layer to the next, the radially outer working layer (62) having an axial width L₆₂ equal to 335 mm and having reinforcers which are crossed with respect to the reinforcers of the radially inner protective layer 51 and which form, with the circumferential direction, an angle equal to 19°, and the radially inner working layer 61 having an axial width L₆₁ equal to 377 mm and having reinforcers that form, with the circumferential direction, an angle equal to 33°,
an additional reinforcement 7 comprising two continuous additional layers (71, 72) formed of inelastic metal reinforcers, crossed from one additional layer to the next, the radially outer additional layer 72 having an axial width L₇₂ equal to 180 mm and having reinforcers that are crossed with respect to the reinforcers of the radially inner working layer 61 and that form, with the circumferential direction, an angle equal to 19°, and the radially inner additional layer 71 having an axial width equal to 377 mm and having reinforcers that form, with the circumferential direction, an angle equal to 33°. Because the additional layers (71, 72) are continuous, there is no axial discontinuity (D₁, D₂).

In the example studied, the crown reinforcement 3 of the tire 1 according to the invention comprises, radially from the outside inwards:
a protective reinforcement 5 comprising two protective layers (51, 52) formed of elastic metal reinforcers, crossed from one protective layer to the next and forming, with the circumferential direction, an angle equal to 24°, the radially outer protective layer 52 having an axial width equal to 232 mm and the radially inner protective layer 51 having an axial width equal to 445 mm,
a working reinforcement 6 comprising two working layers (61, 62) formed of inelastic metal reinforcers, crossed from one working layer to the next, the radially outer working layer (62) having an axial width L₆₂ equal to 377 mm and having reinforcers parallel to the reinforcers of the radially inner protective layer 51 and forming, with the circumferential direction, an angle equal to 19°, and the radially inner working layer 61 having an axial width L₆₁ equal to 335 mm and having reinforcers that form, with the circumferential direction, an angle equal to 33°,
an additional reinforcement 7 comprising two continuous additional layers (71, 72) formed of inelastic metal reinforcers, crossed from one additional layer to the next, the radially outer additional layer 72 having an axial width L₇₂ equal to 282 mm and having reinforcers that are crossed with respect to the reinforcers of the radially inner working layer 61 and that form, with the circumferential direction, an angle equal to 16°, and the radially inner additional layer 71 having an axial width equal to 292 mm and having reinforcers that form, with the circumferential direction, an angle equal to 11°. The additional layers (71, 72) comprise identical axial discontinuities (D₁, D₂) equal to 32 mm

Impact tests on vehicle or numerical simulations have demonstrated a significant gain in impact resistance of the crown of a tire according to the invention as compared with the reference tire.

The invention is not restricted to the features previously described and, for example, may be extended to other types of metal reinforcer guaranteeing the target non-extension rigidity of the additional reinforcement, such as, for example and non-exhaustively, crimped cords or split cords.

1. A tire for heavy vehicle of civil engineering type, comprising:
a crown reinforcement radially on the inside of a tread and radially on the outside of a carcass reinforcement;
the crown reinforcement comprising, radially from the outside towards the inside, a protective reinforcement, a working reinforcement and an additional reinforcement;
the protective reinforcement comprising at least one protective layer comprising elastic metal reinforcers which form, with the circumferential direction, an angle at least equal to 10°;
the working reinforcement comprising at least two working layers respectively having an axial width and comprising inelastic metal reinforcers, crossed from one working layer to the next and which form, with the circumferential direction, an angle at most equal to 60°;
the additional reinforcement, centred axially on an equatorial plane of the tire, comprising at least one additional layer having an axial width at most equal to 0.9 times the shortest of the axial widths of the at least two working layers and comprising metal reinforcers which form, with the circumferential direction, an angle at most equal to 25°,
characterized in that wherein at least one additional layer comprises an axial discontinuity, centred axially on the equatorial plane of the tire, and in that wherein the width of the axial discontinuity is at least equal to 0.1 times the axial width, of the at least one additional layer.

2. The tire for a heavy vehicle of the civil engineering type according to claim 1, wherein the angle formed, with the circumferential direction, by the metal reinforcers of the at least one additional layer is at least equal to 10°.

3. The tire for a heavy vehicle of civil engineering type according to claim 1, wherein the axial width of the at least one additional layer is at least equal to 0.4 times the shortest of the axial widths of the at least two working layers.

4. The tire for a heavy vehicle of the civil engineering type according to claim 1, wherein the width of the axial discontinuity of the at least one additional layer is at most equal to 0.35 times the axial width of the at least one additional layer.

5. The tire for a heavy vehicle of the civil engineering type according to claim 1, the additional reinforcement comprising at least two additional layers, in which wherein the radially innermost additional layer comprises an axial discontinuity.

6. The tire for a heavy vehicle of the civil engineering type according to claim 1, the additional reinforcement comprising at least two additional layers, in which wherein the radially outermost additional layer comprises an axial discontinuity.

7. The tire for a heavy vehicle of the civil engineering type according to claim 1, the additional reinforcement comprising at least two additional layers, in which wherein the at least two additional layers respectively comprise an axial discontinuity.

8. The tire for a heavy vehicle of the civil engineering type according to claim 7, in which wherein the respective axial discontinuities of the at least two additional layers have respective widths that differ one from the other.

9. The tire for a heavy vehicle of civil engineering type according to claim 7, in which wherein the respective axial widths of the at least two additional layers are different one from the other.

10. The tire for a heavy vehicle of civil engineering type according to claim 1, wherin the metal reinforcers of the at least one additional layer are inelastic.

11. The tire for a heavy vehicle of civil engineering type according to claim 1, wherein the metal reinforcers of the at least one additional layer are elastic.

12. The tire for a heavy vehicle of civil engineering type according to claim 1, wherein the elastic metal reinforcers of each protective layer form, with the circumferential direction, an angle at least equal to 15° and at most equal to 30°.

13. The tire for a heavy vehicle of civil engineering type according to claim 1, wherein the inelastic metal reinforcers of each working layer form, with the circumferential direction, an angle at least equal to 15° and at most equal to 45°.
